(19) United States
(12) Patent Application Publication
(10) Pub. No.: US 2022/0399139 A1
(43) Pub. Date: Dec. 15, 2022

(54) CONDUCTOR FOR BUSBAR ELECTRIC WIRE, AND BUSBAR ELECTRIC WIRE

(71) Applicant: YAZAKI CORPORATION, Tokyo (JP)

(72) Inventors: Hiroki Kondo, Susono-shi (JP); Mizuki Shirai, Susono-shi (JP); Takeshi Kamata, Susono-shi (JP)

(21) Appl. No.: 17/744,625

(22) Filed: May 14, 2022

(30) Foreign Application Priority Data
Jun. 15, 2021 (JP) 2021-099476

(51) Int. Cl. H01B 7/08; H01B 7/00; H01B 7/02

(52) U.S. Cl. CPC H01B 7/08; H01B 7/0081; H01B 7/02

(57) ABSTRACT

There are provided a conductor for busbar electric wire, and a busbar electric wire configured by a conductive plate material having a substantially rectangular cross-sectional shape, the conductor including: an opening formed on one side in a width direction orthogonal to a longitudinal direction of the plate material, the width direction corresponding to a planar direction of the plate material.

This application is based on and claims priority under 35 USC 119 from Japanese Patent Application No. 2021-099476 filed on Jun. 15, 2021, the contents of which are incorporated herein by reference.

### TECHNICAL FIELD

The present disclosure relates to a conductor for busbar electric wire and a busbar electric wire.

### BACKGROUND ART

In related art, from the viewpoint of saving space at the time of wiring to a vehicle or the like, a busbar electric wire using a flat conductor having a rectangular (flat) cross section has been proposed (see JP2014-238927A, JP2016-076316A, and JP2018-160317A).

Herein the busbar electric wires described in JP2014-238927A, JP2016-076316A, and JP2018-160317A need to be bent in a planar direction of the flat conductor in order to be wired in accordance with a vehicle shape or the like. At the time of bending in the planar direction, a bending jig having a predetermined bending R is in contact with the inner side of bending. For this reason, in the busbar electric wires described in JP2014-238927A, JP2016-076316A, and JP2018-160317A, at the time of bending in the planar direction, metal of an inner portion of the flat conductor tends to be compressed, which increases a plate thickness of the inner portion and leads to occurrence of cracks. Occurrence of cracks unexpectedly changes the electrical characteristics, which causes a problem that the specification cannot be satisfied.

### SUMMARY OF INVENTION

The present disclosure provides a conductor for busbar electric wire and a busbar electric wire capable of reducing a possibility of cracks occurring in a bending in a planar direction.

According to an illustrative aspect of the present disclosure, a conductor for busbar electric wire configured by a conductive plate material having a substantially rectangular cross-sectional shape, includes: an opening formed on one side in a width direction orthogonal to a longitudinal direction of the plate material, the width direction corresponding to a planar direction of the plate material.

According to the present disclosure, since the one side in the planar direction of the plate material is formed with the opening, when the plate material is bent such that the one side becomes the inner side, the opening is filled by the compression of the inner side, which prevents an increase in the plate thickness. Therefore, it is possible to prevent an increase in the plate thickness on the inner side of bending at the time of bending in the planar direction, thereby reducing the possibility of cracking.

### BRIEF DESCRIPTION OF DRAWINGS

FIG. 1 is a first perspective view illustrating a busbar electric wire according to an embodiment of the present disclosure.

FIG. 2 is a second perspective view illustrating the busbar electric wire according to the embodiment of the present disclosure.

FIG. 3 is a perspective view illustrating a flat conductor of the busbar electric wire illustrated in FIG. 2.

FIG. 4 is a cross-sectional view of the busbar electric wire illustrated in FIG. 2.

FIG. 5 is a top view for illustrating an operation of the busbar electric wire according to the embodiment.

FIG. 6 is a configuration diagram illustrating a flat conductor according to Modification 1.

FIG. 7 is a configuration diagram illustrating a flat conductor according to Modification 2.

FIG. 8 is a configuration diagram illustrating a flat conductor according to Modification 3.

### DESCRIPTION OF EMBODIMENTS

Hereinafter, the present disclosure will be described in accordance with a preferred embodiment. The present disclosure is not limited to the embodiment to be described below, and can be changed as appropriate without departing from the gist of the present disclosure. In addition, although some configurations are not illustrated or described in the embodiment to be described below, it goes without saying that a known or well-known technique is applied as appropriate to details of an omitted technique within a range in which no contradiction occurs to contents to be described below.

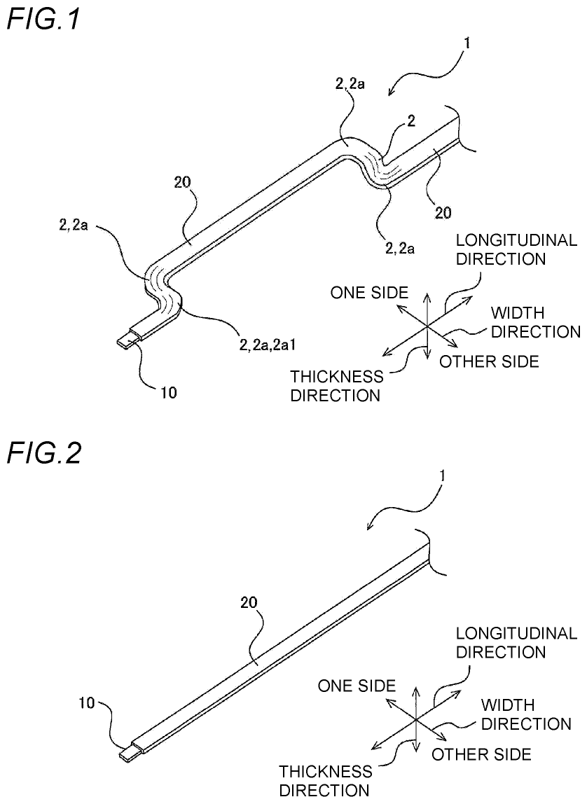

FIG. 1 is a first perspective view illustrating a busbar electric wire according to an embodiment of the present disclosure, and FIG. 2 is a second perspective view illustrating the busbar electric wire according to the embodiment of the present disclosure. As illustrated in FIGS. 1 and 2, a busbar electric wire 1 according to the present embodiment is wired in a vehicle as, for example, a wire harness, and includes a flat conductor (conductor for busbar electric wire) 10 and an insulating sheath 20.

The flat conductor 10 is configured with, for example, a conductive plate material of aluminum, inevitable impurities, and the like, and has a shape of a cross section orthogonal to a longitudinal direction (as for a cross section passing through a void 11b to be described later, a shape of the cross section excluding the void 11b) that is substantially rectangular (including not only a complete rectangular shape but also a rectangular shape having a slightly rounded corner). In the present embodiment, the flat conductor 10 is formed of a single plate, but is not limited thereto, and a plurality of flat conductors 10 may be laminated in a thickness direction. In addition, a plurality of layers may be stacked in a width direction as long as the layers form a rectangular shape that is longer in the width direction than in the thickness direction.

The insulating sheath 20 is configured with an insulator that covers an outer periphery of the flat conductor 10. The insulating sheath 20 is made of, for example, polypropylene (PP), polyethylene (PE), polyvinyl chloride (PVC), or the like.

In the present embodiment, the flat conductor 10 has a predetermined plate thickness and a predetermined plate width, so as to ensure no less than a predetermined cross-sectional area (for example, a cross-sectional area of 15 mm² or more (a total cross-sectional area as for a flat conductor 10 constituted by a plurality of plates or the like instead of a single plate)), so that the flat conductor 10 can be used as a power supply wire.

Such a busbar electric wire 1 (flat conductor 10) according to the present embodiment is manufactured so as to have a substantially linear shape as illustrated in FIG. 2, and is bent to include a bent portion 2 illustrated in FIG. 1 when wired in a vehicle, so as to match a shape of the vehicle. A bent portion 2a as a part of the bent portion 2 is bent in a planar direction (in-plane direction) of the flat conductor 10.

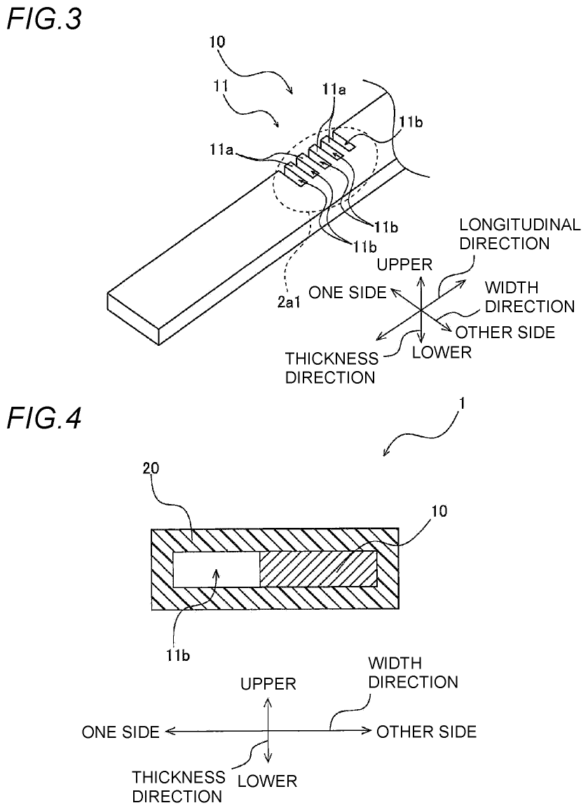

FIG. 3 is a perspective view illustrating the flat conductor 10 of the busbar electric wire 1 illustrated in FIG. 2, and FIG. 4 is a cross-sectional view of the busbar electric wire 1 illustrated in FIG. 2. The flat conductor 10 illustrated in FIG. 3 illustrates the vicinity of a specific bent portion 2a1 bent to one side in the planar direction as illustrated in FIG. 1, and FIG. 4 illustrates a cross section passing through a portion denoted by reference numeral 11b illustrated in FIG. 3.

As illustrated in FIG. 3, the flat conductor 10 has a comb tooth portion 11 at a position corresponding to the specific bent portion 2a1. The comb tooth portion 11 is formed on one side in the planar direction of the flat conductor 10 (hereinafter, one side when the flat conductor 10 is divided into two in the width direction orthogonal to the longitudinal direction is referred to as one side, and the other side is referred to as the other side), and has an uneven shape. More specifically, the comb tooth portion 11 has a plurality of plate portions 11a extending toward the one side, and a plurality of voids (openings) 11b are formed by hollowing out positions on both sides (both sides along the longitudinal direction of the flat conductor 10) of the plate portions 11a. In the present embodiment, a center of gravity of the voids 11b is located on the one side of the flat conductor 10 in a plan view of the flat conductor 10.

In the busbar electric wire 1 according to the present embodiment, the insulating sheath 20 is provided on the flat conductor 10 by tube extrusion or the like. As illustrated in FIG. 4, the insulating sheath 20 is not filled in the voids 11b formed in the flat conductor 10. In the example illustrated in FIG. 4, the voids 11b are not filled with the insulating sheath 20 at all. However, as long as the voids 11b are at least partially not filled and an action to be described later can be obtained, the voids 11b may also be filled with a small amount of the insulating sheath 20. Specifically, at least 20% or more of the entire voids 11b is not filled, preferably 50% or more are not filled, and more preferably 80% or more of the entire voids 11b is not filled.

Although only the vicinity of the specific bent portion 2a1 is illustrated in FIG. 3, the other bent portions 2a illustrated in FIG. 1 are similarly formed with the comb tooth portion 11 illustrated in FIG. 3 on the inner side of bending.

Next, the operation of the busbar electric wire 1 according to the present embodiment will be described. FIG. 5 is a top view for illustrating the operation of the busbar electric wire 1 according to the embodiment. In FIG. 5, the flat conductor 10 and a bending jig BJ are indicated by solid lines, and the insulating sheath 20 is indicated by broken lines.

When the linear busbar electric wire 1 illustrated in FIG. 2 is formed with the bent portions 2a (specific bent portion 2a1) as illustrated in FIG. 1, the bending jig BJ is disposed on the one side (inner side of bending) in the planar direction. A worker bends the busbar electric wire 1 along the bending jig BJ to form the bent portions 2a each having a predetermined bending R.

Here, as illustrated in FIG. 5, when the busbar electric wire 1 is bent in the planar direction, the inner side of bending of the flat conductor 10 is in a compressed state. In addition, due to the presence of the bending jig BJ, the metal constituting the flat conductor 10 cannot escape to the inner side, and the plate thickness of the flat conductor 10 tends to increase. Cracks may be generated due to the increase in the plate thickness.

In the present embodiment, however, the comb tooth portion 11 is formed on the one side (inner side of bending) in the planar direction of the flat conductor 10. Further, the insulating sheath 20 is not filled in at least a part of the voids 11b of the comb tooth portion 11. Therefore, the shape of the flat conductor 10 is changed so as to fill the voids 11b of the comb tooth portion 11 when the flat conductor 10 is bent in the planar direction, thereby preventing the increase in the plate thickness.

In particular, not only the increase in the plate thickness is prevented, but also the plate portions 11a are brought into contact with each other so as to fill the voids 11b, so that a current can flow through the plurality of plate portions 11a, which can be utilized to maintain the electrical characteristics.

In the example illustrated in FIG. 5, the plurality of plate portions 11a (see FIG. 3) are in contact with each other, but the cross-sectional area of the flat conductor 10 and the like may also be determined to ensure electrical characteristics on the assumption that the plurality of plate portions 11a are not in contact with each other.

Here, as illustrated in FIG. 5, the busbar electric wire 1 is bent to have the bending radius R by using the bending jig BJ. At this time, a distance b from a bending center CL of the busbar electric wire 1 to a center of the bending jig BJ is preferably 2.44 mm or more. As a result of intensive studies conducted by the inventors of the present disclosure, measurement was performed while changing a length and the like of the voids 11b to various values, and it has been found that when the distance b from the bending center CL to the center of the bending jig BJ is 2.44 mm or more, for example, cracks did not occur even at R5 in an object in which cracks occurred at R15 in a case without the comb tooth portion 11, which means that the crack reduction effect is dramatically improved. Therefore, it can be said that the distance b is preferably 2.44 mm or more.

The plate portions 11a are preferably thin, and preferably have, for example, a thickness along the longitudinal direction of the flat conductor 10 of 7.5 mm or less. This is because that thin plate portions 11a are less likely to increase the thickness of the flat conductor 10 upon the compression at the time of bending.

A distance between the voids 11b (a distance between the plate portions 11a) is preferably long, and is preferably, for example, 1.0 mm or more. This is because that a long distance between the voids 11b is less likely to increase the thickness of the flat conductor 10 upon the compression at the time of bending.

In this way, according to the flat conductor 10 of the present embodiment, since the one side in the width direction of the plate material is formed with the voids 11b, when the plate material is bent such that the one side becomes the inner side, the voids 11b are filled by the compression of the inner side, which prevents an increase in the plate thickness. Therefore, it is possible to prevent an increase in the plate thickness on the inner side of bending at the time of bending in the planar direction, thereby reducing the possibility of cracking.

According to the busbar electric wire 1 of the present embodiment, since the insulating sheath 20 is not filled in at least a part of the voids 11b, it is possible to prevent the insulating sheath 20 from being completely filled in the voids 11b, thereby preventing the function of filling the voids 11b from being difficult to achieve when the busbar electric wire 1 is bent in the planar direction.

Since the busbar electric wire 1 is bent along the plate surface at the portion where the voids 11b are formed, such that the one side of busbar electric wire 1 the is on the inner side, it is possible to provide a busbar electric wire 1 that can prevent the occurrence of cracks while realizing the predetermined bending R.

Although the present disclosure has been described based on the embodiment, the present disclosure is not limited to the embodiment described above. The present disclosure may be modified as appropriate without departing from the gist of the present disclosure, or may be combined with known or well-known techniques as appropriate if possible.

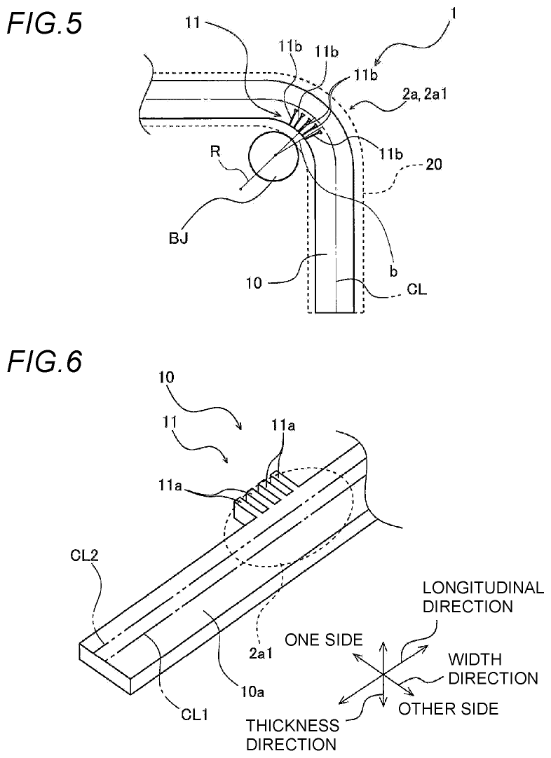

FIGS. 6 to 8 are configuration diagrams illustrating the flat conductor 10 according to Modifications 1 to 3. As illustrated in FIG. 6, the flat conductor 10 according to Modification 1 includes a comb tooth portion 11 that protrudes from one side of a body portion 10a extending at the same width in the longitudinal direction.

Here, in a case without including the protruding comb tooth portion 11, the bending center CL1 using the bending jig BJ (see FIG. 5) is a line indicated by a one-dot chain line in FIG. 6. That is, the bending center CL1 is a width center line of the body portion 10a. On the other hand, in a portion including the protruding comb tooth portion 11, the bending center CL2 using the bending jig BJ is a line indicated by a two-dot chain line in FIG. 6. That is, in a portion formed with the protruding comb tooth portion 11, the bending center CL2 is displaced from the width center line of the body portion 10a. As a result, it is possible to obtain the same function as the function described in the specific bent portion 2a1 with reference to FIG. 5, and it is possible to reduce the possibility of crack occurrence.

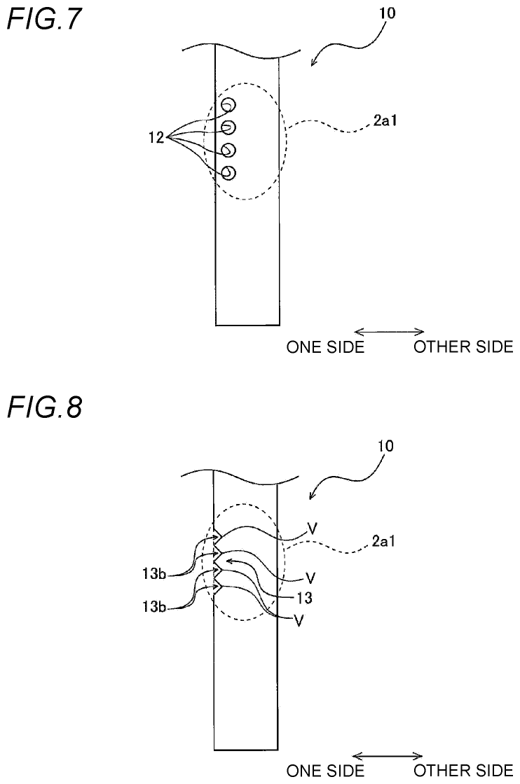

The bent portion 2a (specific bent portion 2a1) is not limited to the case where the comb tooth portion 11 is formed, and may be formed with through holes (opening) 12 penetrating the flat conductor 10 in the thickness direction as illustrated in FIG. 7. In this configuration, a center of gravity of the through holes 12 is located on the one side of the flat conductor 10, and when the flat conductor 10 is bent to the one side in the planar direction, the shape of the flat conductor 10 is changed so as to fill the through holes 12, whereby it is possible to reduce the possibility of crack occurrence.

Further, without being limited to the comb tooth portion 11 having the voids 11b that are rectangular in a plan view, a V-shaped notch 13 has voids (openings) 13b that are triangular in a plan view as illustrated in FIG. 8. In this configuration as well, a center of gravity of the voids 13b is located on the one side of the flat conductor 10, and when the flat conductor 10 is bent to the one side in the planar direction, the shape of the flat conductor 10 is changed so as to fill the voids 13b, whereby it is possible to reduce the possibility of crack occurrence. In addition, when each void 13b has a shape having one vertex V on the other side as in the V-shaped notch 13 illustrated in FIG. 8, the void 13b can be easily filled at the time of bending to the one side, and electrical characteristics can be easily realized after filling the void 13b.

Comparing the comb tooth portion 11, the through holes 12, and the V-shaped notch portion 13, it is preferable to adopt the comb tooth portion 11 and the V-shaped notch portion 13 rather than the through holes 12. Here, the comb tooth portion 11 and the V-shaped notch 13 have a shape opened to the one side, whereas the through holes 12 are not opened to the one side. Therefore, at the time of bending, an end surface on the one side is compressed, and the plate thickness is likely to increase. However, the plate thickness is less likely to increase in the case of a shape opened to the one side, such as the comb tooth portion 11 and the V-shaped notch 13. Therefore, it is preferable to adopt the comb tooth portion 11 and the V-shaped notch portion 13 rather than the through holes 12.

Comparing the comb tooth portion 11 and the V-shaped notch portion 13, it is preferable to adopt the comb tooth portion 11 rather than the V-shaped notch portion 13. This is because the V-shaped notch portion 13 has a shape having pointed tips on the one side, and thus may be deformed at the time of bending using the bending jig BJ. Such deformation may disable the originally assumed crack prevention effect. On the other hand, in the case of the comb tooth portion 11, since the tips on the one side are flat surfaces, the shape thereof cannot be easily changed by the bending jig BJ. Therefore, it is preferable to adopt the comb tooth portion 11 rather than the V-shaped notch portion 13.

In the above description, the voids 11b, 13b and the through holes 12 penetrate in the thickness direction of the flat conductor 10, but are not particularly limited to penetrating. For example, a recess that has a bottom without penetrating in the thickness direction may be adopted as well. As a matter of course, a penetrating configuration is preferred for being more likely to obtain the effect of filling the voids 11b, 13b, and the like than a recess.

According to a first aspect of the present disclosure, a conductor for busbar electric wire (10) configured by a conductive plate material having a substantially rectangular cross-sectional shape, includes: an opening (11b, 12, 13b) formed on one side in a width direction orthogonal to a longitudinal direction of the plate material, the width direction corresponding to a planar direction of the plate material.

According to a second aspect of the present disclosure, a busbar electric wire (1) may include: the conductor for busbar electric wire (10) according to the first aspect; and an insulating sheath (20) that is an insulator covering the conductor for busbar electric wire (10). At least a part of the opening (11b, 12, 13b) may have a non-filled portion in which the insulating sheath (20) is not filled.

According to a third aspect of the present disclosure, the busbar electric wire (1) may further include: a bent portion (2, 2a, 2a1) formed by bending, towards the one side along the planar direction of the plate material, a portion (2, 2a, 2a1) having the opening (11b, 12, 13b) on the one side that is an inner side of bending.

What is claimed is:

1. A conductor for busbar electric wire configured by a conductive plate material having a substantially rectangular cross-sectional shape, comprising:
an opening formed on one side in a width direction orthogonal to a longitudinal direction of the plate material, the width direction corresponding to a planar direction of the plate material.

2. A busbar electric wire comprising:
the conductor for busbar electric wire according to claim 1; and
an insulating sheath that is an insulator covering the conductor for busbar electric wire, wherein
at least a part of the opening has a non-filled portion in which the insulating sheath is not filled.

3. The busbar electric wire according to claim 2, further comprising:
a bent portion formed by bending, towards the one side along the planar direction of the plate material, a portion having the opening on the one side that is an inner side of bending.
